(19) United States
(12) Patent Application Publication
(10) Pub. No.: US 2007/0050214 A1
(43) Pub. Date: Mar. 1, 2007

(54) APPARATUS, SYSTEM, AND METHOD FOR ASSESSING AND MANAGING BEHAVIORAL RISK

(76) Inventors: Rick Hawks, North Ogden, UT (US); Kent Allen, Eden, UT (US); Gary Dansie, Murray, UT (US); Todd Musig, Sandy, UT (US)

Correspondence Address: KUNZLER & ASSOCIATES, 8 EAST BROADWAY, SUITE 600, SALT LAKE CITY, UT, 84111, US

(21) Appl. No.: 11/460,874

(22) Filed: Jul. 28, 2006

Related U.S. Application Data
(60) Provisional application No. 60/703,948, filed on Jul. 29, 2005.

(51) Int. Cl. G06Q 10/00; G06F 19/00

(52) U.S. Cl. 705/3; 705/2

(57) ABSTRACT

An apparatus, system, and method are disclosed for assessing and managing behavioral risk. The present invention maintains an episode module configured to collect behavioral risk data, a risk assessment module configured to allow a user to assess behavioral risk in relation to environmental factors, and a treatment module configured to generate recommended treatment options. Beneficially, such an apparatus, system, and method takes into account the dynamic nature of behavioral risk and provides tools to aid in estimating behavioral risk, managing and communicating behavioral risk, and documenting adherence to a standard of care.

### CROSS-REFERENCES TO RELATED APPLICATIONS

This application claims the benefit of U.S. Provisional Patent Application No. 60/703,948 entitled “Apparatus, System, and Method for assessing and managing behavioral risk” and filed on Jul. 29, 2005 for Rick Hawks, et al., which is incorporated herein by reference.

### BACKGROUND OF THE INVENTION

### Description of the Related Art

Historically, there have been three basic approaches for evaluating behavioral risk: unstructured professional judgment, structured professional judgment, and actuarial. These terms refer to behavioral risk assessment models which provide information on how data is weighted and combined to reach a final decision about behavioral risk. These decision making models fail to take into consideration the characteristics associated with the course and nature of behavioral risk. Below is a brief description of these three procedures.

Unstructured professional judgment is an unaided decision-making process, completed in the absence of structure. It can be characterized as “intuitive” or “experiential.” Historically, it has been the most commonly used procedure. It has the advantage of being highly adaptable, given intuition is available in almost any circumstance. The major problem is that there is little empirical evidence that the process is consistent across evaluators or that it actually predicts or prevents harmful behavior. This quality of the process relies heavily on the person who makes the decision.

Structured professional judgment is a decision-making approach assisted by guidelines that have been developed to reflect empirical knowledge and professional practice. Such guidelines are referred to as clinical guidelines, best practice guidelines, or a standard of care. Typically these guidelines provide a set of core behavioral risk factors that according to the professional literature should be considered as part of any behavioral risk assessment. This approach is a “middle ground” approach. It limits the intuitive decision-making of the unstructured professional judgment by providing guidelines, but lacks the objectivity of actuarial procedures.

An actuarial procedure uses actuarial behavioral risk assessment instruments. In contrast to other tests, actuarial behavioral risk assessment instruments are designed solely to predict the future. They are used for a particular population over a specific period of time. The factors are usually selected on the basis of their association with the outcome in research. The individual items are typically weighted. Actuarial instruments have the advantage of transparency and direct empirical support. These instruments are similar with respect to format, being relatively brief checklists based primarily on static or historical factors and result in a percentage of recidivism given a period of time. The use of an unstructured professional judgment and actuarial instrument are viewed as opposite ends of a continuum in terms of reliance on research and following empirical guidelines.

The historical approaches for assessing behavioral risk fail to account for the dynamic nature of behavioral risk. Behavioral risk is not a diagnosis like depression, schizophrenia or other mental disorder which has associated boundaries with a unique set of symptoms. Behavioral risk is variable and represents a likelihood of some harmful behavior occurring given a certain environment. Behavioral risk changes and is influenced by several factors, such as a changing environment, differing levels of monitoring, and changing expectations.

Behavioral health professionals tasked with caring for patients subject to behavioral risk face the constant difficulties of estimating and managing behavioral risk in their patients. Historical approaches for assessing and managing behavioral risk lack tools for tracking changing behavioral risk environments, and therefore fail to provide tools for estimating changing levels of behavioral risk as a result of those changing environments.

These professionals also face the threat of litigation resulting from the actions of their patients. One defense against such litigation is a well-documented history of adherence to a standard of care.

From the foregoing discussion, it should be apparent that a need exists for an apparatus, system, and method for assessing and managing behavioral risk. Beneficially, such an apparatus, system, and method would take into account the dynamic nature of behavioral risk and provide tools to aid in estimating behavioral risk, managing and communicating behavioral risk, and documenting adherence to a standard of care.

### SUMMARY OF THE INVENTION

The present invention has been developed in response to the present state of the art, and in particular, in response to the problems and needs in the art that have not yet been fully solved by currently available apparatuses, systems, and methods for assessing and managing behavioral risk. Accordingly, the present invention has been developed to provide an apparatus, system, and method for assessing and managing behavioral risk that overcome many or all of the above-discussed shortcomings in the art.

The apparatus for assessing and managing behavioral risk is provided with a plurality of modules configured to functionally execute the necessary steps to accomplish assessing and managing behavioral risk. These modules in the described embodiments include an episode module, a risk assessment module, and a treatment module.

The apparatus, in one embodiment, is a is a computer program product comprising a computer useable medium including a computer readable program, the computer program product when executed on a computer causes the computer to execute an episode module configured to collect behavioral risk data for evaluating behavioral risk for a patient based on environmental factors over a period of time, a risk assessment module configured to allow a user to estimate the behavioral risk posed by the patient in relation to the environmental factors over the period of time, and a treatment plan module configured to generate a recommended set of treatment options for the patient in response to the collected behavioral risk data.

In one embodiment of the computer program product, the episode module further includes a snapshot module configured to collect behavioral risk data for a patient based on environmental factors at an instant in time. The computer program product is further configured, in one embodiment, with a risk assessment module configured to require the user to estimate the behavioral risk posed by the patient in relation to the environmental factors.

In a further embodiment, the computer program product may be configured to include a treatment plan module with a management plan module configured to generate a recommended set of patient management options for the patient in response to the collected behavioral risk data, and a communication plan module configured to generate a recommended set of communication options for the patient in response to the collected behavioral risk data.

In another embodiment, the computer program product includes a user interface accessible by way of the internet. The episode module in the computer program product, in another embodiment, further includes one or more questions, each question comprising a query and one or more possible responses to the query, wherein behavioral risk data is collected through the selection of at least one response to a query.

The computer program product, in another embodiment, includes at least one response to a query linked to a treatment option. In another embodiment, the computer program product includes a question management module configured to modify the one or more queries and possible responses to the queries. In a further embodiment, the computer program product includes a question management module is further configured to modify linkages between responses and treatment options.

In yet another embodiment, the computer program product includes a question management module is further configured to modify one or more of queries, responses, and linkages to customize the treatment options to match the needs of a particular type of risk. The computer program product also includes, in one embodiment, a treatment module configured to modify the treatment options to match the needs of a treatment facility.

A system of the present invention is also presented for assessing and managing behavioral risk. The system may be embodied by a risk assessment management system (RAMS), a control room interface, and a network. In particular, the system, in one embodiment, includes a RAMS comprising a snapshot module configured to collect behavioral risk data for evaluating behavioral risk for a patient based on environmental factors at an instant in time, a risk assessment module configured to require a user to estimate the behavioral risk posed by the patient in relation to the environmental factors at the instant in time, a management plan module configured to generate a recommended set of management options for the patient in response to the collected behavioral risk data, and a communication plan module configured to generate a recommended set of communication options for the patient in response to the behavioral risk data; a control room interface configured to modify attributes of the RAMS; a user interface configured to communicate with the RAMS; and a network configured to allow communication between the RAMS, the control room interface, and the user interface.

The system may further include a control room interface with a security module configured to restrict access to the control room interface to an administrator. In another embodiment, the system may include a security module configured to control access to the control room interface to authorized users.

The system, in one embodiment, may include an output device configured to generate records of one or more of management options and communication options that document a standard of care. In another embodiment, the communication module of the system may be further configured to automatically send messages over a network relating to the care of a patient in response to a communication plan. In another embodiment, the system may include a user guidance module configured to assist a user in the proper evaluation of a patient.

A method of the present invention is also presented to assess and manage behavioral risk. The method in the disclosed embodiments substantially includes the steps necessary to carry out the functions presented above with respect to the operation of the described apparatus and system. In one embodiment, the method includes collecting behavioral risk data for evaluating behavioral risk for a patient based on environmental factors at an instant in time, requiring a user estimation of the behavioral risk posed by the patient in relation to the environmental factors at the instant in time, and generating a recommended set of treatment options for the patient in response to the collected information. The method also may include collecting behavioral risk data by responding to questions.

In a further embodiment, the method includes responding to questions that are grouped into categories that impact risk. In another embodiment, the method includes setting default values for behavioral risk data to a previous value collected for that patient, such that the behavioral risk data includes historical data. In yet another embodiment of the method, the behavioral risk data may be accorded a weight in relation to the relative importance of the behavioral risk data in determining behavioral risk.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for assessing and managing behavioral risk in accordance with the present invention;

FIG. 2 is a schematic block diagram illustrating one embodiment of an apparatus for a behavioral risk assessment and management system;

FIG. 3 is a schematic block diagram illustrating one embodiment of an apparatus for a snapshot module in a behavioral risk assessment and management system;

FIG. 4 is a schematic block diagram illustrating one embodiment of an apparatus for a behavioral risk assignment module in a behavioral risk assessment and management system;

FIG. 5 is a schematic block diagram illustrating one embodiment of an apparatus for a question management module in a behavioral risk assessment and management system;

FIG. 6 is a schematic block diagram illustrating one embodiment of an apparatus for a management plan module and a communication plan module in a behavioral risk assessment and management system;

FIG. 7 is a schematic flow chart diagram illustrating one embodiment of a behavioral risk assessment and management method in accordance with the present invention; and

FIG. 8 is a schematic flow chart diagram illustrating one embodiment of a question management method in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

“Patient” as used herein comprises a patient, client, or individual receiving treatment for behavioral issues. “User” as used herein comprises a practitioner, doctor, health care professional, or person assessing behavioral risk. “Harm” as used herein comprises bodily harm to self bodily harm to others, or sexual harm to others. “Behavioral risk” as used herein comprises the likelihood that a patient will cause harm.

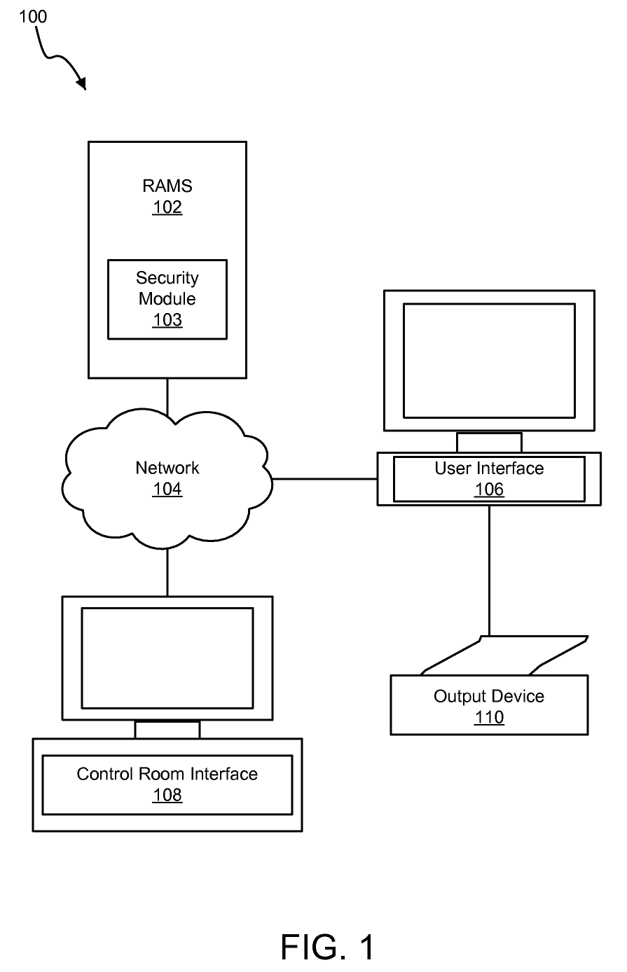

FIG. 1 illustrates one embodiment for a system for assessing and managing behavioral risk 100 including a behavioral risk assessment and management system (RAMS) 102, a network 104, a user interface 106, a control room interface 108, and an output device 110. The system for assessing and managing behavioral risk 100 aids in caring for patients who pose a behavioral risk of harm to themselves or others.

The RAMS 102, in one embodiment, is connected to the network 104 and comprises a software application and database for assessing and managing behavioral risk. The RAMS 102 is capable of collecting behavioral risk data about a patient posing a behavioral risk at an instant in time. This data collected at instant in time is known as a “snapshot.”

The snapshot represents an assessment of behavioral risk at a moment in time. By evaluating the behavioral risk at a moment in time, the user can account for the relationship of the patient to their “risk environment.” A risk environment includes such factors as circumstances, events, expectations of others, boundaries, family relationships, level of monitoring, presence of chaos and stress, access to potential victims or lethal means, and other factors related to an environment in a broad sense.

Typically, a risk environment is associated with a particular physical location or group of locations. Before one can adequately assess behavioral risk, there must be a correct conceptual understanding of its nature and its ability to be influenced by the risk environment. By collecting behavioral risk data and assessing behavioral risk for snapshots, the user can better understand and manage the overall behavioral risk posed by a patient.

The collected snapshot data may be categorized with respect to specific environmental factors. The RAMS 102 is capable of prompting for and collecting assessments of behavioral risk levels from one or more practitioners working with the patient. These behavioral risk levels may be categorized with respect to specific environmental factors.

In another embodiment, the RAMS 102 may collect data about a patient posing a risk of harm to self or harm to others over a period of time. This data collected over a period of time is referred to as an “episode.” The collected episode data may be categorized with respect to specific environmental factors.

By collecting behavioral risk data and making behavioral risk assessments in episodes and snapshots, the user can provide better care for the patient. The RAMS 102 provides the user with a system capable of collecting behavioral risk data and monitoring the changeable nature of behavioral risk based on risk environments.

As will be appreciated by one skilled in the art, a variety of types and configurations of RAMS 102 may be utilized without departing from the scope and spirit of the present invention. For example, in one embodiment, the RAMS 102 may comprise an application and a database connected to a local network. In another embodiment, the RAMS 102 may comprise a software package located on a local computer. In another embodiment, the RAMS 102 may comprise machine readable code on a signal bearing medium.

In one embodiment, the RAMS 102 may include a security module 103 that manages access rights to the RAMS 102. The security module 103 may restrict access to those who provide a security credential, such as a user name and a password. In a further embodiment, the security module may allow different rights to different users.

The security module 103, in one embodiment, may define certain users as administrators, and allow administrators to access the control room interface 108 and restrict other users from access to the control room interface 108. In one embodiment, administrators may include service providers, certain administrative users at a treatment facility, or the like.

The network 104, in one embodiment, is connected to the RAMS 102, the user interface 106, and the control room interface 108. The network 104 provides a pathway for the interfaces to communicate with the RAMS 102. In one embodiment, the network 104 may comprise the Internet, enabling remote connections to the RAMS 102, the user interface 106, and the control room interface 108. In an alternate embodiment, the network 104 may comprise a limited-access intranet.

In one embodiment, the connections through the network 104 are web-based connections secured with encryption, such as SSL encryption. In an alternative embodiment, the connections through the network 104 are application specific.

The user interface 106, in one embodiment, provides a means for a user to input data to be communicated to the RAMS 102. The user interface 106 may be connected to the network 104. The user interface 106 may comprise a web browser or a personal computer, in one embodiment.

One skilled in the art will recognize that many types of user interface 106 should be considered to be within the scope of the invention. For example, the user interface 106 may comprise a terminal attached to a network, in one embodiment. In another embodiment, the user interface 106 may comprise an application installed locally on the hard drive of a computer with the RAMS 102. In another embodiment, the user interface 106 may be in communication with the RAMS 102 through a local network.

The control room interface 108, in one embodiment, provides a means for an administrator to modify configuration settings and other attributes of the RAMS 102. The control room interface 108 may be connected to the network 104. The control room interface 108 may comprise a personal computer.

One skilled in the art will recognize that many types of control room interface 108 should be considered to be within the scope of the invention. For example, the control room interface 108 may comprise a terminal attached to a network, in one embodiment. In another embodiment, the control room interface 108 may comprise an application installed locally on the hard drive of a computer with the RAMS 102. In another embodiment, the control room interface 108 may be attached to the RAMS 102 through a local network.

The output device 110, in one embodiment, allows the user to create hard copy records of behavioral risk assessments and treatment, management, and/or communication plans. Hard copy records may assist the user in establishing adherence to a standard of care. The output device 110 may be connected to the user interface 106.

In another embodiment, the output device 110 may be connected to the RAMS 102. In a further embodiment, the output device 110 may comprise a means of recording data in a dense format, such as microfilm, magnetic data, or the like. In another embodiment, the output device 110 may be a printer that produces printed documentation.

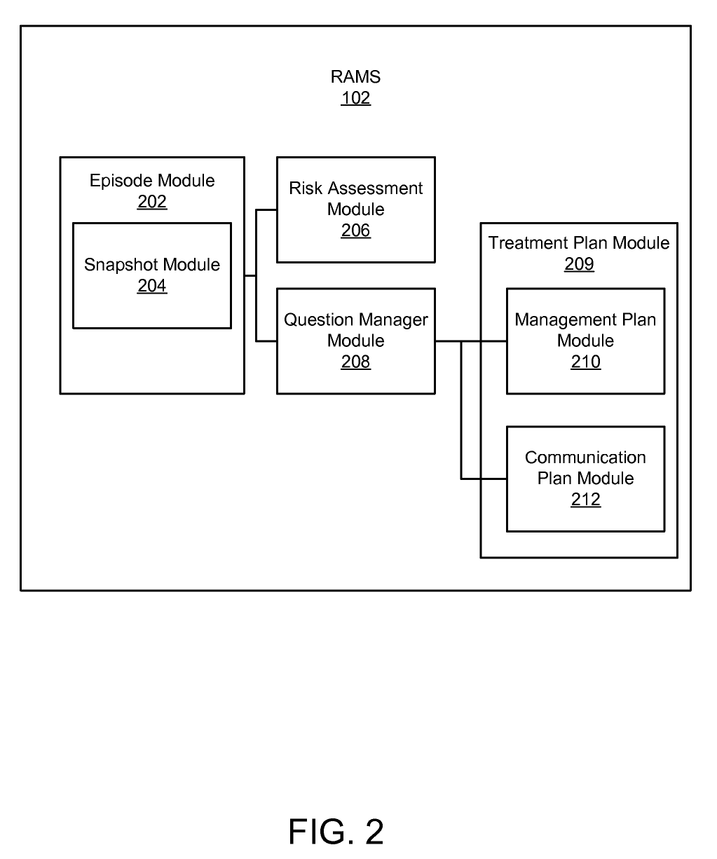

FIG. 2 illustrates one embodiment of an apparatus for a RAMS 102. The RAMS 102 comprises an episode module 202, a snapshot module 204, a risk assessment module 206, a question manager module 208, a treatment plan module 209, a management plan module 210, and a communication plan module 212. The RAMS 102, in one embodiment, comprises a computer application to collect information about a patient, assist in estimating the behavioral risk for harm to self or harm to others that patient poses, and assist in generating management and communication plans for that patient.

The episode module 202 may include a snapshot module 204. The episode module 202 receives inputs from the user interface 106 in response to questions that help determine behavioral risk. The questions, in one embodiment, may include queries with one or more possible responses that relate to the behavioral risk of a patient. The behavioral risk data captured by the episode module 202 encompasses a time frame of indeterminate length from the beginning of an episode to the end of an episode.

An episode is a period of time during which the patient is subject to behavioral risk. An episode may be triggered by an external event, such as a court order, law enforcement, interaction with others, or the like. An episode may also be self-initiated such as a patient who self-enrolls into care.

The snapshot module 204, in one embodiment, receives inputs from the user interface 106 in response to questions that help determine behavioral risk. The data captured by the snapshot module 204 encompasses an instant in time and reflects the behavioral risk of the patient at that moment in a specific environment. The snapshot module 204 collects behavioral risk data as a subset of an episode in the episode module 202. Each episode may include one or more snapshots provided by the snapshot module 204.

In one embodiment, the questions in the episode module 202 and the snapshot module 204 may be based on research such as clinical studies that indicate a relationship between the responses to the questions and behavioral risk. In another embodiment, the responses to questions may have discrete ranges, such as a yes/no response, a set of ranges such as low, guarded, elevated, high, or severe, or the like.

The risk assessment module 206, in one embodiment, prompts the user to assign a behavioral risk level to the patient for each episode generated by the episode module 202 and each snapshot generated by the snapshot module 204. The risk assessment module 206 may also prompt the user to assign behavioral risk levels for subsets of snapshots. In one embodiment, the user is required to assign a behavioral risk level before closing a snapshot or episode.

The question manager module 208, in one embodiment, manages the questions and possible responses presented in the episode module 202 and the snapshot module 204. The user may access the question manager module 208 through the user interface 106 in one embodiment. In another embodiment, an administrator may access the question manager module 208 through the control room interface 108. In yet another embodiment, an administrator may access the question manager module 208 through the user interface 106. In one embodiment, access to the question manager module 208 is restricted by the security module 103 to authorized users, such as administrators.

The question manager module 208 allows a user to create, delete, or modify the questions, queries, and/or possible responses to those questions. This allows the RAMS 102 to be customized or adjusted as needed. In a further embodiment, the question manager module 208 allows a user to link responses to the questions to treatment options in the treatment plan module 209, management options in the management plan module 210, and/or communication options in the communication plan module 212. In yet another embodiment, the responses may be linked to multiple treatment, management, and communication options. In a further embodiment, linkages between responses and treatment, management, and/or communication options may be modified by the question manager module 208

In another embodiment, the question manager 208 allows a user to create guidance or hints for the user. This guidance may assist the user in posing questions to a patient. In another embodiment, the guidance may assist the user in determining satisfactory answers to questions.

In one embodiment, the question manager module 208 allows a user to modify the questions, queries, responses, and linkages to suit treatment of a particular type of risk. For example, in one embodiment, the questions may be tailored with queries and responses that are known to be helpful in determining risk related to post traumatic stress disorder (PTSD). Additionally, linkages may be tailored to generate treatment options known to be helpful in treating PTSD. Other examples of types of risk that may have tailored questions include suicide, domestic violence, and the like.

In a further embodiment, the question manager module 208 allows a user to modify the treatment, management, and/or communication options to suit the capabilities of a particular treatment facility. For example, an outpatient care facility may have one set of management options, while an inpatient care facility may have another set of treatment options.

The treatment plan module 209, in one embodiment, assists the user in creating a treatment plan for the patient. A treatment plan comprises actions that will be taken to manage the behavioral risk of the patient and communication with the patient, communication with the patient's family, placing written documentation in the patient's file, communication with a community, law enforcement, or governmental agency, and the like. In one embodiment, the treatment plan module 209 comprises a management plan module 210 and a communication plan module 212.

The treatment plan module 209 suggests possible treatment options to the user which can be selected by the user to create the treatment plan. The selected options form a treatment plan that can be recorded and pursued through treatment of the patient.

In one embodiment, the treatment plan module 209 may present treatment options in response to responses to questions in the episode module 202. The treatment plan module 209 may also present treatment options as a result of responses to questions in the snapshot module 204. The question manager module 208 may define a relationship between responses to questions and treatment options such that certain responses to certain questions lead to recommendation of one or more particular treatment options.

The management plan module 210, in one embodiment, assists the user in creating a management plan for the patient. A management plan comprises actions that will be taken to manage the behavioral risk of the patient. Examples of these actions include mental health medication, therapy, psychological testing, and the like.

The management plan module 210 suggests possible management options to the user which can be selected by the user to create the management plan. The selected options form a management plan that can be recorded and pursued through treatment of the patient.

The management plan module 210 may present options as a result of responses to questions in the episode module 202. The management plan module 210 may also present options as a result of responses to questions in the snapshot module 204. The question manager module 208 may define a relationship between responses to questions and management options.

The communication plan module 212, in one embodiment, assists the user in creating a communication plan for the patient. A communication plan comprises communication with the patient, communication with the patient's family, placing written documentation in the patient's file, communication with a community agency, and the like.

The communication plan module 212 suggests possible communication options to the user which may be selected by the user to create the communication plan. The selected options form a communication plan that can be recorded and pursued through treatment of the patient.

The communication plan module 212 may present options as a result of responses to questions in the episode module 202. The communication plan module 212 may also present options as a result of responses to questions in the snapshot module 204. The question manager module 208 may define a relationship between responses to questions and communication options.

Since management and communication options may be linked to responses to questions in a systematic manner through the question manager module 208, management plans generated by the RAMS 102 may assist the user in adherence to a standard of care and help ensure best practices. Since the RAMS 102 records the questions, responses, and plans generated, the RAMS 102 may also assist the user in documenting adherence to that standard of care.

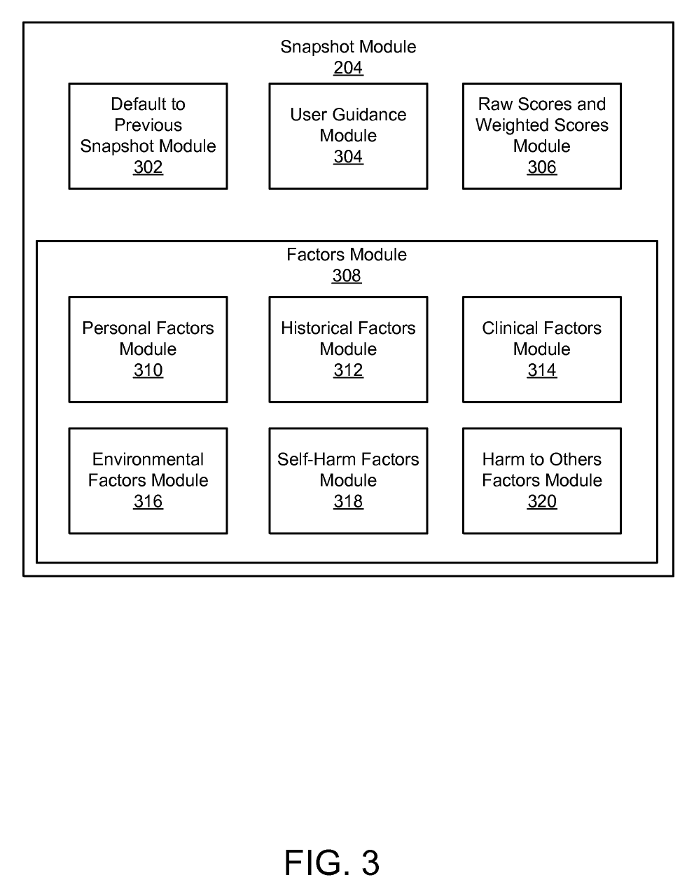

FIG. 3 illustrates one embodiment of a snapshot module 204 in a RAMS 102. The snapshot module 204 may comprise a default to previous snapshot module 302, user guidance module 304, a raw scores and weighted scores module 306, and a factors module 308. The snapshot module 204 captures behavioral risk data that may be indicative of the behavioral risk posed by a patient at a moment in time.

In one embodiment, the snapshot module 204 includes a default to previous snapshot module 302 that automatically sets responses in the snapshot module 204 to default to values set in a previous snapshot. If the snapshot is the first snapshot for the patient, the default values may be set to unknown, null, or zero. If a previous snapshot exists, the information from that snapshot will provide historical data for a patient and assist the user in determining behavioral risk changes in the patient. By setting those previous values as a default, the user can more easily determine changes, predict trends, and complete a snapshot.

The user guidance module 304, in one embodiment, may comprise guidance to assist the user in asking questions in the snapshot module 204 and/or the episode module 202. By providing guidance, the RAMS 102 may assist the user in sufficiently evaluating the patient. Examples of this guidance may include clarifications or definitions of terminology, links to research establishing the relevance of the question to behavioral risk assessment, examples of wording for sample questions, and the like.

The raw scores and weighted scores module 306 in one embodiment, displays results of the questions in an episode, a snapshot, or a subset of a snapshot. The raw score represents the total number of assets or answers indicating lower behavioral risk to the questions and liabilities or answers indicating higher behavioral risk to the questions. The weighted score incorporates the degree of the assets and liabilities. For example, a liability rated as “severe” may weight the liability score more heavily than a liability rated as “high.” The raw and weighted scores assist the user in assessing risk.

In one embodiment, the factors module 308 comprises one or more categories of factors that impact behavioral risk. Questions in the snapshot module 204 may be organized into these factors to help the user understand the nature of the risk environment at the moment of the snapshot. The factors module 308 may comprise sub-modules such as a personal factors module 310, a historical factors module 312, a clinical factors module 314, an environmental factors module 316, a self-harm factors module 318, and a harm to others factors module 320.

The personal factors module 310 may comprise questions that relate to the personal interactions of the patient. Examples of questions that may be included in the personal factors module 310 include questions relating to personal relationships, work, self-esteem, developmental level, and the like.

The historical factors module 312 may comprise questions that relate to past events that may influence the patient's risk environment. Examples of questions that may be included in the historical factors module 312 include questions about past physical abuse of the patient, past substance abuse by the patient, past diagnoses of behavioral disorders, and the like.

The clinical factors module 314 may comprise questions that relate to current clinical factors that influence the patient's risk environment. Examples of questions that may be included in the clinical factors module include questions about current drug or alcohol abuse, depression, perception of reality, and the like.

The environmental factors module 316 may comprise questions that relate to the patient's environment as it now exists. An identified environment may include any one or a combination of work, school, community, or home setting. Examples of questions that may be included in the environmental factors module 316 include questions about patient monitoring, access to weapons, access to individuals at risk of being harmed by the patient, and the like.

The self-harm factors module 318 may comprise questions that relate to risk of self-harm that may influence the patient's risk environment. Examples of questions that may be included in the self-harm factors module 318 include questions about past episodes of self-harm, depression, expressing an intent to cause self-harm, and the like.

The harm to others factors module 320 may comprise questions that relate to indicators that a patient may cause harm to others. Examples of questions that may be included in the harm to others factors module 320 include questions about aggression, past episodes of harm to others, past episodes of damage to property, cruelty to animals, and the like.

By evaluating the patient at a moment in time and compiling the behavioral risk data as a snapshot, the user can better account for the dynamic nature of behavioral risk. As the risk environment for the patient varies, the behavioral risk for the patient varies. Through snapshot evaluation and tracking, the user may achieve a better understanding of the factors that influence the risk environment of the patient, be better prepared to take steps to modify the risk environment, and improve patient care.

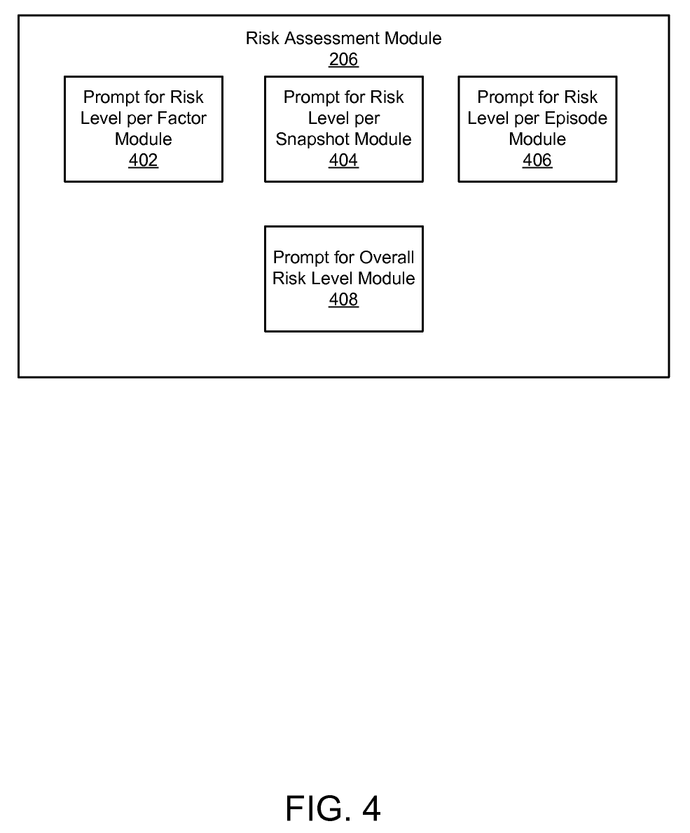

FIG. 4 illustrates one embodiment of a risk assignment module 206. The risk assignment module prompts the user to assign a behavioral risk level to the patient with respect to factors, snapshots, episodes, and/or overall risk. The risk assignment module may include a prompt for risk level per factor module 402, a prompt for risk level per snapshot module 404, a prompt for risk level per episode module 406, and a prompt for overall risk level module 408.

Assessing behavioral risk level is done by the user. The RAMS 102 provides the user with tools and structure to better understand the risk environment and more uniformly provide care for behavioral risk. The behavioral risk data collected in the episode module 202 and the snapshot module 204 are summarized and presented to the user by the raw scores and weighted scores module 306.

The user may use the data and scores to assist in assigning risk levels. This represents a structured approach to assessing behavioral risk. The user may also rely on intuition or experience to assess behavioral risk. This represents an unstructured approach to assessing behavioral risk.

The prompt for risk level per factor module 402, in one embodiment, may prompt the user to assign a behavioral risk level to the patient with respect to a factor. This behavioral risk level is indicative of the behavioral risk imparted to a patient as the result of a particular factor. By evaluating the behavioral risk on a per-factor basis, the user can better evaluate the types of intervention that will best mitigate the behavioral risk.

Similarly, the prompt for risk level per snapshot module 404 may prompt the user to assign a behavioral risk level to a patient with respect to a snapshot. This behavioral risk level is indicative of the overall behavioral risk level for the patient at a moment in time. Evaluating the behavioral risk level for each snapshot facilitates understanding of trends in risk level over time within an episode and helps account for the dynamic nature of behavioral risk.

The prompt for risk level per episode module 406 may prompt the user to assign a behavioral risk level to a patient with respect to an episode. This behavioral risk level is indicative of the behavioral risk level for the patient throughout the course of an episode. The prompt for overall risk level module 408 may prompt the user to assign a behavioral risk level to a patient that reflects the overall risk of the patient.

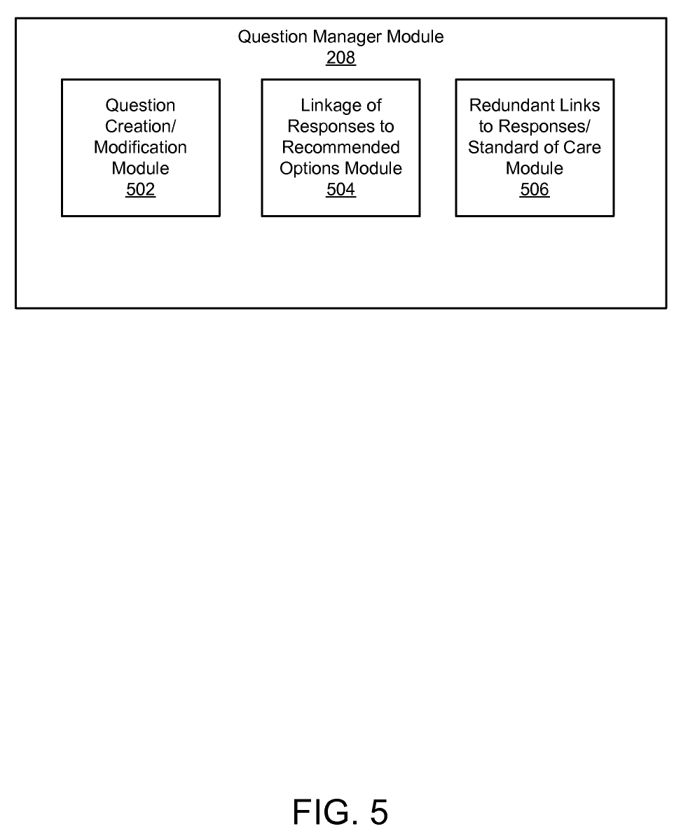

FIG. 5 illustrates one embodiment of a question manager module 208. The question manager module 208 manages the questions and possible responses presented in the snapshot module 204 and/or the questions and possible responses presented in the episode module 202. The question manager module 208 may also manage links between responses and recommended actions in the treatment plan module 209, the management plan module 210, and/or the communication plan module 212. The question manager module may comprise a question creation/modification module 502, a linkage of responses to recommended options module 504, and a redundant links to responses module 506.

The question creation/modification module 502 allows the user and/or an administrator to control the questions posed in the RAMS 102. Questions may be created and added to factors, snapshots, or episodes. Similarly, existing questions may be modified or placed in a different factor, snapshot, or episode.

In one embodiment, the question creation/modification module 502 allows the user and/or the administrator to assign allowed potential responses to questions. The allowed potential responses may be yes/no/unknown responses, a discrete range of responses, such as low/medium/high/very high, a text response box, or the like.

The linkage of responses to recommended options module 504, in one embodiment, allows the user and/or an administrator to link a response to a question to a treatment option, a management option and/or a communication option. The linked option appears in the treatment plan module 209, the management plan module 210, or the communication plan module 212 as a recommended treatment option, a recommended management option, or a recommended communication option when triggered by the response. By linking recommended treatment options to specific responses, the RAMS 102 assists the user in maintaining a standard of care because appropriate treatment, management, or communication options are consistently suggested and thereby more likely to be followed.

In one embodiment, the redundant links to responses module 506 allows the user and/or an administrator to link a response to a single question to more than one treatment, communication, and/or management option. More than one recommended option may result from the response in the communication plan module 212 and/or the management plan module 210.

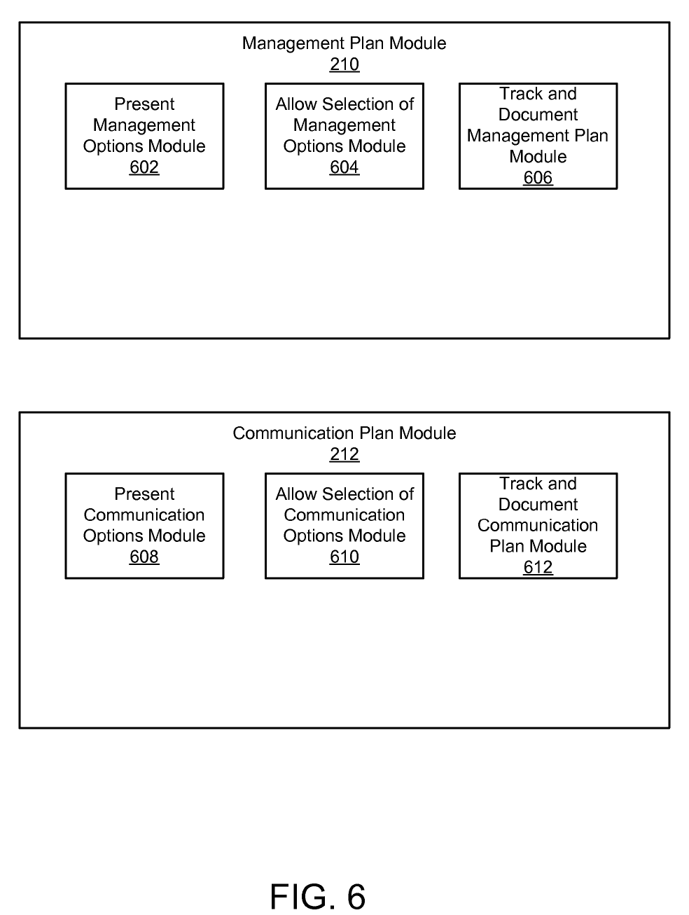

FIG. 6 illustrates one embodiment of a management plan module 210 and a communication plan module 212. The management plan module 210 creates a management plan for the patient and the communication plan module 212 creates a communication plan for the patient. Together, these plans represent the treatment plan for managing the behavioral risk posed by the patient.

The management plan module 210 assists the user in creating a management plan for the patient. A management plan comprises actions that will be taken to manage the behavioral risk of the patient. Examples of these actions include mental health medication, therapy, psychological testing, and the like. The management plan module 210 may comprise a present management options module 602, an allow selection of management options module 604, and a track and document management plan module 606.

In one embodiment, the present management options module 602 presents one or more options for managing the behavioral risk of the patient. The one or more options presented are selected in response to the linkages managed by the question manager module 208. The one or more options presented are dynamically assigned as a result of the responses to the questions asked in the episode module 202 and/or the snapshot module 204.

The allow selection of management options module 604, in one embodiment, allows the user to select which, if any, of the recommended management options to include in the management plan for the patient. In another embodiment, the user may add management options to the management plan in addition to the recommended management options. In yet another embodiment, the user may include notes or comments in relation to specific management options or the overall management plan.

By presenting recommended management options tailored to the responses given for the patient, the management plan module 210 provides an opportunity for a structured approach to behavioral risk management. By allowing the addition of management options to the management plan beyond those recommended by the RAMS 102, the management plan module 210 provides an opportunity for the user to pursue an unstructured approach to behavioral risk management. A user may also employ a combination of structured and unstructured approaches by adding management options to the recommended management options. This hybrid approach allows an experienced practitioner to follow intuition and professional judgment while maintaining a standard of care.

In one embodiment, the track and document management plan module 606 allows the user to review management plans for a patient and determine how well the management plan has been followed. The track and document management plan module 606 may also allow for documentation of the management plan and its course through electronic storage, printed paper copies, or the like. The track and document management plan module 606 may assist in establishing adherence to a standard of care. This documentation may be beneficial in future patient treatment, research, or litigation.

The communication plan module 212, in one embodiment, assists the user in creating a communication plan for the patient. A communication plan comprises communication with the patient, communication with the patient's family, placing written documentation in the patient's file, communication with a community agency, and the like. The communication plan module 212 may comprise a present communication options module 608, an allow selection of communication options module 610, and a track and document communication plan module 612.

The communication plan module 212 and its components, in one embodiment, are similar in operation and purpose to the management plan module 210 and its components. The communication plan module 212 also presents opportunities for the user to pursue a structured approach, an unstructured approach, or a hybrid approach to behavioral risk management.

In one embodiment, the present communication options module 608 presents one or more options for communicating the behavioral risk of the patient. The one or more options presented are selected in response to the linkages managed by the question manager module 208. The one or more options presented are dynamically assigned as a result of the responses to the questions asked in the episode module 202 and/or the snapshot module 204.

The allow selection of communication options module 610, in one embodiment, allows the user to select which, if any, of the recommended communication options to include in the communication plan for the patient. In another embodiment, the user may add communication options to the communication plan in addition to the recommended communication options. In yet another embodiment, the user may include notes or comments in relation to specific communication options or the overall communication plan.

In one embodiment, the track and document communication plan module 612 allows the user to review communication plans for a patient and determine how well the communication plan has been followed. The track and document communication plan module 612 may also allow for documentation of the communication plan and its course through electronic storage, printed paper copies, or the like. The track and document communication plan module 612 may assist in establishing adherence to a standard of care. This documentation may be beneficial in future patient treatment, research, or liability management.

In a further embodiment, the track and document communication plan module 612 may allow a user to automatically generate communications as part of the communication plan. The messages may comprise warnings, reminders, and/or notices to particular persons or agencies involved in working with the patient. For example, a message warning of a particular weak period for a patient combating an addiction may be sent to family members to solicit additional support. In one embodiment, messages relating to care of a patient may be sent over a network in response to a communication plan. For example, e-mail messages may be generated and delivered through the internet. Other examples of automatically generated messages include messages to pagers, short message service (SMS) text messages, and the like. These automated messages may be tracked by the RAMS 102 and used to document adherence to a standard of care.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

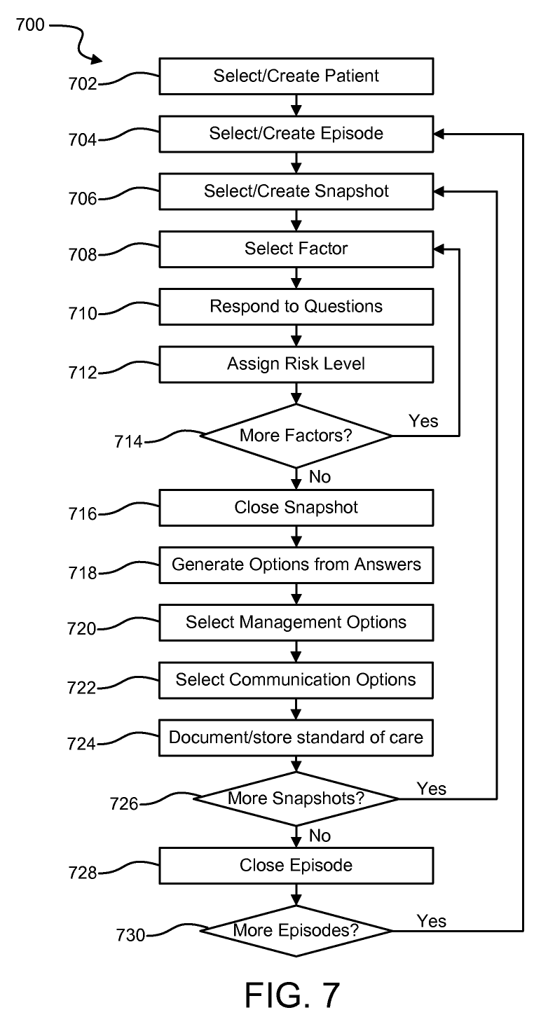

FIG. 7 illustrates a flow chart for a method 700 for behavioral risk assessment and management. Initially, a user selects/creates 702 a patient. If the patient has previously been created, the user selects the client from a patient list. If the patient has not previously been entered into the method 700, the user creates the patient. Creating a patient, in one embodiment, comprises entering certain biographical information about the patient, such as name, gender, date of birth, address, and the like. In one embodiment, certain biographical data is required to create the patient while other data is not required to create the patient.

Next, the user selects/creates 704 an episode. If an episode has previously been created and not closed, the user selects the episode from an episode list. If no open episode is available, the user creates a new episode for the patient. In one embodiment, the user may input the event or circumstance that prompted the user to open an episode for the patient. An episode represents a period of time over which behavioral risk for a patient is assessed and managed.

Next, the user selects/creates 706 a snapshot. If a snapshot has previously been created and not closed, the user selects the snapshot from a snapshot list. If no open snapshot is available, the user creates a new snapshot for the patient. A snapshot represents an instant in time in which an assessment is taken for a patient.

By opening a snapshot for a patient, the user can better track the changing nature of behavioral risk as a function of external factors. By assessing behavioral risk in relation to these factors, the user can craft treatment plans that mitigate the negative effects of those factors and improve the treatment of the patient.

In one embodiment, the user may be required to enter data relating to the snapshot, such as what prompted the user to open the snapshot, the patient's environment, the sources of information consulted to complete the snapshot, and the like. In another embodiment, the user may be required to enter confidentiality information, such as notification of the patient of privacy issues, and notification of a parent or guardian, if necessary.

Next the user selects 708 a factor. Factors represent types of risk environments in which questions that aid in assessing behavioral risk are grouped. Examples of factors include personal factors, historical factors, clinical factors, environmental factors, self-harm factors, and harm to others factors. These factors are similar in nature to similarly named factors described in relation to FIG. 3 above.

Next, the user responds 710 to questions in the selected factor. The questions aid in assessing behavioral risk, and may include suggestions, hints, and links to research for the user as described in relation to FIG. 3 above.

Next, the user assigns 712 a risk level for the patient with regard to the selected factor. The user may be required to select from a range of risk levels, such as low/guarded/elevated/high/severe. The user may base this risk level on the patient's answers to the questions posed in the factor, the user's experience and intuition, and/or a combination of patient answers and user intuition.

Next, the user determines 714 if more factors need to be pursued. If the user elects to pursue another factor, the user returns to the select 708 factor step. If the user elects to not pursue another factor, the user continues to the next step.

Next, the user closes 716 the snapshot. The user closes the snapshot when the evaluation of behavioral risk at the moment in time is completed. In one embodiment, when the snapshot is closed it can no longer be edited or modified by the user.

Next, the method 700 generates 718 options from answers. The options generated are the management and/or communication options generated in response to answers to questions posed in the snapshot and/or the episode. In one embodiment, management and/or communication options are linked to responses to questions as described in relation to FIG. 5 and FIG. 6.

Next, the user selects 720 management options. The method 700, in one embodiment, presents the generated management options to the user, and the user may select which of these options to incorporate into the management plan. In another embodiment, the user may select 720 and incorporate options not presented by the method into the management plan. In one embodiment, the user selects 720 the management options in a manner similar to that described in relation to FIG. 6.

Next the user selects 722 communication options. The method 700, in one embodiment, presents the generated communication options to the user, and the user may select which of these options to incorporate into the communication plan. In another embodiment, the user may select 722 and incorporate options not presented by the method into the communication plan. In one embodiment, the user selects 722 the communication options in a manner similar to that described in relation to FIG. 6.

Next, the method 700 documents and stores 724 indicia of adherence to a standard of care. In one embodiment, the method 700 documents and stores 724 this indicia by recording the questions asked, the responses to the questions, the management plan, the communication plan, and the course the management and communication plans.

Next, the user determines 726 if more snapshots should be opened. If the user determines that a new evaluation at a moment in time would be beneficial for the patient's treatment, the user returns to the select/create 706 snapshot step. If the user elects to not open another snapshot, the user may proceed to the next step.

Next, the user closes 728 the episode. When the user determines that the behavioral risk of the patient no longer needs to be managed, the user may close 720 the episode. Examples of circumstances that may lead user to conclude that an episode should be closed include improvement in the patient's behavioral risk and transfer of the patient to another care provider.

Next, the user may determine 730 if more episodes should be opened. If the user determines that the behavioral risk of the patient needs to be managed again, the user can open a new episode by returning to the select/create 704 episode step and creating a new episode. Examples of circumstances that may prompt the user to determine that a new episode should be opened include a worsening of the patient's behavioral risk, a request by the patient that monitoring and assessment be resumed, and return of the patient from another care provider.

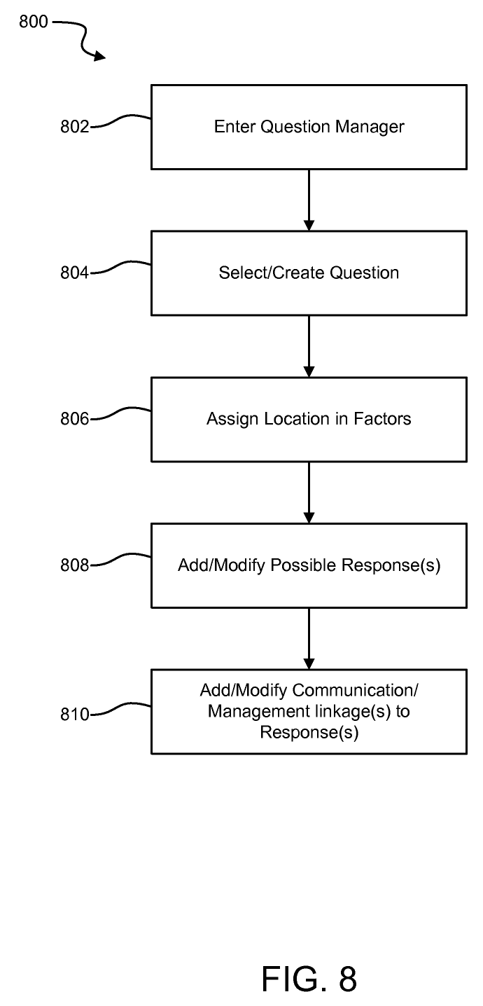

FIG. 8 illustrates a flowchart for a method 800 for managing questions in a RAMS 102. Initially, a user enters 802 a question manager. In one embodiment, the user may be any user of the RAMS 102. In another embodiment, the user may be a user with special rights to manage questions. In yet another embodiment, the user is an administrator.

Next, the user selects/creates 804 a question. If the user wishes to modify an existing question, the user selects that question. If the user wishes to create a new question, the user creates a new question.

Next, the user assigns 806 a location for the question to appear in the factors. In one embodiment, the user may assign in which factor the question appears and in what order the question appears. In another embodiment, the user may assign the question to more than one factor. In another embodiment, the user may assign the question to a snapshot. In yet another embodiment, the user may assign the question to an episode.

Next, the user adds/modifies 808 one or more potential responses to the question. In one embodiment, the user may add or modify a potential response to a question that comprises a discrete set of ranges, such as yes/no/unknown, low/moderate/high/severe, or the like. In another embodiment, the user may add a text box as a potential response to a question.

Next the user adds/modifies 810 communication and/or management linkages to the responses. In one embodiment, the user may link a response to one or more communication and or management options. The linked one or more options are presented in the management or communication plans as recommended options as a result of the response.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product comprising a computer readable medium having computer usable program code programmed for assessing and managing behavioral risk, the operations of the computer program product comprising:
an episode module configured to collect behavioral risk data for evaluating behavioral risk for a patient based on environmental factors over a period of time;
a risk assessment module configured to allow a user to estimate the behavioral risk posed by the patient in relation to the environmental factors over the period of time; and
a treatment plan module configured to generate a recommended set of treatment options for the patient in response to the collected behavioral risk data.

2. The computer program product of claim 1, wherein the episode module further comprises a snapshot module configured to collect behavioral risk data for a patient based on environmental factors at an instant in time.

3. The computer program product of claim 1, wherein the risk assessment module is further configured to require the user to estimate the behavioral risk posed by the patient in relation to the environmental factors.

4. The computer program product of claim 1, wherein the treatment plan module further comprises:
a management plan module configured to generate a recommended set of patient management options for the patient in response to the collected behavioral risk data; and
a communication plan module configured to generate a recommended set of communication options for the patient in response to the collected behavioral risk data.

5. The computer program product of claim 1, further comprising a user interface accessible to a user by way of the internet.

6. The computer program product of claim 1, wherein the episode module further comprises one or more questions, each question comprising a query and one or more possible responses to the query, wherein behavioral risk data is collected through the selection of at least one response to a query.

7. The computer program product of claim 6 wherein at least one response to a query is linked to a treatment option.

8. The computer program product of claim 7, further comprising a question management module configured to modify the one or more queries and possible responses to the queries.

9. The computer program product of claim 8, wherein the question management module is further configured to modify linkages between responses and treatment options.

10. The computer program product of claim 9, wherein the question management module is further configured to modify one or more of queries, responses, and linkages to customize the treatment options to match the needs of a particular type of risk.

11. The computer program product of claim 9, wherein the treatment module is further configured to modify the treatment options to match the needs of a treatment facility.

12. A system for assessing and managing behavioral risk, the system comprising:
a risk assessment management system (RAMS) comprising:
a snapshot module configured to collect behavioral risk data for evaluating behavioral risk for a patient based on environmental factors at an instant in time;
a risk assessment module configured to require a user to estimate the behavioral risk posed by the patient in relation to the environmental factors at the instant in time;
a management plan module configured to generate a recommended set of management options for the patient in response to the collected behavioral risk data; and
a communication plan module configured to generate a recommended set of communication options for the patient in response to the behavioral risk data;
a control room interface configured to modify attributes of the RAMS; a user interface configured to communicate with the RAMS; and
a network configured to allow communication between the RAMS, the control room interface, and the user interface.

13. The system of claim 12, wherein the control room interface further comprises a security module configured to restrict access to the control room interface to an administrator.

14. The system of claim 12, wherein the control room interface further comprises a security module configured to control access to the control room interface to authorized users.

15. The system of claim 12, further comprising an output device configured to generate records of one or more of management options and communication options that document a standard of care.

16. The system of claim 12, wherein the communication plan module is further configured to automatically send messages over a network relating to the care of a patient in response to a communication plan.

17. The system of claim 12, further comprising a user guidance module configured to assist a user in the proper evaluation of a patient.

18. A method to assess and manage behavioral risk, the method comprising:
collecting behavioral risk data for evaluating behavioral risk for a patient based on environmental factors at an instant in time;
requiring a user estimation of the behavioral risk posed by the patient in relation to the environmental factors at the instant in time; and
generating a recommended set of treatment options for the patient in response to the collected information.

19. The method of claim 18, wherein collecting behavioral risk data further comprises responding to questions.

20. The method of claim 19 wherein the questions are grouped into categories that impact risk.

21. The method of claim 18, wherein the behavioral risk data collected for a patient defaults to a previous value collected for that patient, such that the behavioral risk data includes historical data.

22. The method of claim 18, wherein behavioral risk data may be accorded a weight in relation to the relative importance of the behavioral risk data in determining behavioral risk.
